(19) United States
(12) Patent Application Publication
(10) Pub. No.: US 2007/0077343 A1
(43) Pub. Date: Apr. 5, 2007

(54) Process of concentrating tea and/or herbal aroma and beverages or flavors using the resulting concentrated aroma

(76) Inventors: Sheng Xue Ma, Shanghai (CN); Eric Jesse Wolff, Chalfont, PA (US)

Correspondence Address: INTERNATIONAL FLAVORS & FRAGRANCES INC., 521 WEST 57TH ST, NEW YORK, NY, 10019, US

(21) Appl. No.: 11/241,893

(22) Filed: Sep. 30, 2005

(51) Int. Cl. A23F 3/00

(52) U.S. Cl. 426/597

(57) ABSTRACT

The present invention relates to a process for preparing concentrated tea and herbal aromas by specific treatment using tea and herb materials as a starting material and to a process of preparing a perfumery composition or a beverage by adding the resulting concentrated tea and/or herbal aroma component that is stable at ambient storage conditions for at least one year.

### BACKGROUND OF THE INVENTION

1. Field of the Invention

The present invention relates to a process for preparing concentrated tea and herbal aromas by specific treatment using tea and herb materials as a starting material, to a process of preparing a concentrated tea and herbal aromas that is stable at ambient storage temperature for at least one year, and to a process of preparing a perfumery composition or a flavor composition by adding the resulting concentrated tea and/or herbal aroma component.

2. Description of the Related Art

Conventionally, tea powder, coffee powder and the like have been produced by putting materials such as tea leaves and coffee beans into an extraction tank to extract with hot water, and, after the separation of an extract solution, the extract is concentrated to a proper solids level using conventional processes such as thermal evaporation and reverse osmosis, or adjusting the extract to the proper concentration with dextrin or the like, and then subjecting the resultant product to spray drying or vacuum freeze-drying. However, they have some problems in flavor quality when they are in hot water; namely, those with dextrin added therein are given flavors different from the original flavors of tea and coffee, and those dried according to spray drying are poor in flavor which is the special feature of tea and coffee, and particularly a light flavor note disappears.

The recovery of flavor substances by using a spinning cone column (hereinafter simply referred to as “SCC”) used in the process of the present invention and mass-transfer equipment are explained in “1st Conference of Food Engineering, 1991, AlChE, Chicago, Ill.”. Also, it is disclosed in the specification of WO90/02493 that vegetables and fruits such as tomatoes, apples and pears are processed using the SCC to obtain a high viscosity component having a low flavor. There are detailed descriptions concerning the design of a column of the SCC in “I. Chem. E. Symp. Series, A128, 167-179, 1992”. The SCC is also used in a process of the recovery of volatile components such as flavors wherein a volatile component (ethanol) is recovered at lower temperatures from a culture solution of fermented yeast (see Process Biochemistry, Vol. 31, No. 7, pp. 651-658, 1995).

A spinning cone column and a Process of removing volatile components from a solution are disclosed in JP-B-7-22646. There is a report that in the recovery of the flavor components of apples and red berry fruits, the level of the content of free and combined sulfurous acid is lowered to 5 ppm or less (Food and Container, Vol. 39, No. 7, pp. 406-408, 1988). In the recovery of flavor components in Flavourtech (see the specification of U.S. Pat. No. 4,996,945), high recovery rates are obtained in the processing of beer flavors, apples, oranges, grapes, apricots or strawberries flavors.

In the past an extract solution from tea leaves is obtained by separation of an extract solution and spent tea leaves carried out according to a process such as pressing and centrifugal separation. The extract solution obtained according to the above Process is condensed by means of a reverse osmosis membrane before subject to spray drying during which most flavor components are destroyed or lost, and the resultant tea powder is normally poor in flavors.

The advantage of using SCC in tea or coffee extraction is that the tea or coffee aroma is stripped before the tea or coffee solids is extracted. The tea or coffee aroma is collected through condenser and could be added back to the concentrated tea or coffee extract before or after spraying drying, which is a big forward step in improving flavor quality. However, due to the concentration of the collected tea or coffee aroma is very low, it is impossible to add back to the tea powder after spraying drying to achieve required aroma strength. Therefore, further concentration of the tea or coffee aroma is a must step, especially for use as a flavor building block. The traditional concentration processes such as thermal distillation under vacuum, solvent extraction, and reverse osmosis (RO) have produce a lower quality product or with significantly different flavor profile.

Another problem associated with SCC generated tea and/or coffee aroma is that they are not stable at ambient storage conditions and have to be stored in chilled conditions. Even so, the shelf life is still very limited due to its higher water content and water activity. Therefore, it is critically important that the finial concentrated tea and/or coffee aroma is stable at ambient storage conditions, which will allow its more broad applications.

According to the present invention it has been surprisingly found that by introducing the tea aroma to the spinning cone column a second time under preset conditions, we could actually concentrate the tea aroma to a very high concentration while maintaining the same flavor profile to its diluted aroma, which is a significant improvement as compared to the methods of the prior arts. More importantly, the second SCC step makes it possible for producing a shelf stable tea and/or coffee aroma that can be stored at ambient conditions and is concentrated enough for many applications.

### SUMMARY OF THE INVENTION

The present invention provides a process for the preparation of a concentrated tea aromas and/or herbal aromas which is stable at ambient storage conditions and may be used as a flavor building block and may be added to beverages, flavor compositions or perfumery compositions.

According to one embodiment of the present invention there is provided: a process for the preparation of a concentrated tea aroma, the process comprising the steps of adding certain amount of tea leaves into a sealed grinder system; then adding the leaves and with purified water into a feeding tank; mixing and dissolving these components thoroughly with stirring to form a uniform tea slurry; introducing the resulting slurry into a SCC and treating the slurry in the following condition: the offset temperature (T_{SCC feed}−T_{SCC}) between about −100° C. to about 50° C. and an external stripping rate between about 0.5 and about 50%; collecting the tea aroma from the spinning cone column while the tea solids is separated from the spent tea leaves and further processed to make concentrated tea extract or spray dried tea powder; reintroducing the collected tea aroma through the spinning cone column a second time with the following conditions: the offset temperature of about −100 to about 0° C.; an external stripping rate of about 1 to about 50%; and providing a concentrated tea aroma for use in formulating tea flavors.

In yet a further embodiment of the present invention concentrated herbal may also be provided according to the processes described above.

In another embodiment a process for the preparation of a beverage comprising concentrated tea aromas and/or herbal aromas is provided.

In yet another embodiment a process for the preparation of a flavor comprising concentrated tea aromas and/or tea aromas is provided.

### DESCRIPTION OF THE INVENTION

It has been surprisingly found that a concentrated tea aroma can be obtained by subjecting tea leaves to a spinning cone column (SCC) forming a diluted tea aroma and then introducing the diluted tea aroma to the spinning cone column for a second time under preset conditions to provide a highly concentrated tea aroma with excellent flavor profiles. The highly concentrated tea aroma could be mixed with certain amount of food-graded alcohol to provide a stable and concentrated tea aroma.

Preferably examples of tea aromas in the present invention include black tea, green tea, oolong tea, yellow tea, white tea, toasted tea, barley tea, and brown rice tea. Additionally, herbal aromas are also contemplated by the present invention, which include, but not limited to mint, chamomile, basil, lavender, lemon balm, rose, anise hyssop, jasmine, chrysanthemum, osmanthus, medlar, lily, violet, honeysuckle, sage, thyme, ginger, ginseng, gingko, and mixtures thereof.

Specifically, the process comprises the steps of: adding certain amount of tea leaves or mixture of tea leaves and herbs above into a sealed grinder system. The purpose of a grinding step is to increase the extraction and yield and efficiency. Then the grinded tea leaves or mixture of tea leaves and herbs may be added with about 7 to 10 times by weight of the tea leaves of purified water having a temperature from about 0 to about 100° C. If the tea leaves have already been grinded when purchased from the manufacturer, the grinding step can be omitted and the fine tea leaves can be directly added into the feeding tank and mix with water to form the tea slurry. The next step comprises mixing and dissolving these components thoroughly with stirring to form a uniform tea slurry; introducing the resulting slurry into a spinning cone column (SCC) and treat the slurry in the following condition: the offset temperature (T_{SCC feed}−T_{SCC}) between about −100° C. to about 50° C. an external stripping rate between about 0.5 and about 50%; collecting the tea aroma from the spinning cone column while the tea solids is separated from the spent tea leaves and further processed to make concentrated tea extract or spray dried tea powder. The concentrated tea aroma may be spray-dried by any methods known by one skilled in the art. Reintroducing the tea aroma through the spinning cone column a second time with the following conditions: the offset temperature of about −100 to about 0° C. and an external stripping rate of about 1 to about 50%.

According to the present invention, the concentrated tea aroma may be subsequently adding back to the concentrated tea extract before spray-drying by process well known in the art or to the spray-dried tea powder right after spray-drying. The concentrated tea aroma may be added in a spray-dried form or in a liquid form to a beverage or other finished products in an amount of 0.001 to 20% by weight. The concentrated tea aroma may also be used as a flavor ingredient to formulate tea flavors used in various products at the level from about 0.1 to about 70% by weight. The concentrated tea aromas and/or herbal aromas may also be used in combination with a food-grade alcohol to provide a stable and concentrated tea product.

The present invention also contemplates the concentration of herbal aroma that may be provided according to the same process described. The herbal aroma may be used in combination with the concentrated tea aroma in beverages and flavors or may be used in separate applications at the same level amounts.

In order to demonstrate the invention, the following examples were conducted. All U.S. Patent and Patent applications referenced herein are hereby incorporated by reference as if set forth in their entirety. The following disclosures are provided to exemplify the present invention.

Unless noted to the contrary all weights are weight percent. Upon review of the foregoing, numerous adaptations, modifications and alterations will occur to the reviewer. These adaptations, modifications, and alterations will all be within the spirit of the invention. Accordingly, reference should be made to the appended claims in order to ascertain the scope of the present invention.

### EXAMPLE 1

### Preparation of Green Tea Aroma

100 kg of green tea leaves were grinded in a mill and then mixed with 1233 kg of water to form 1333 kg of slurry in a mixing tank. The tea slurry was added into the SCC from the top and counter currently extracted with 97 kg of steam introduced from the bottom of the spinning cone column with an ESR of 2.0%, an offset temperature of −25° C. and a heat loss of 10 kg/h. 27 kg of aroma was recovered and 1403 kg of tea slurry was also collected. Then the slurry was added to a decanter wherein 1168 kg of extract was recovered composed of 31 kg of soluble solids, 1131 kg of water and 6 kg of insoluble solids. The extract was then centrifuged and 1109 kg of extract solution was recovered composed of 30 kg of soluble solids, 1079 kg of water and 1 kg of insoluble solids. Also recovered was 58 kg of sludge composed of 2 kg of soluble solids, 51 kg of water and 5 kg of insoluble solids. Overall there was an 82.2% soluble solids recovery with a yield of 0.30 kg soluble solids/kg of green tea leave.

### EXAMPLE II

### Preparation of Black Tea Aroma

100 kg of black tea leaves were added and mixed with 1233 kg of water to form 1333 kg of slurry in a mixing tank. The tea slurry was added into the SCC from the top and counter currently extracted with 97 kg of steam introduced from the bottom of the spinning cone column with settings of ESR of 2.0%, offset temperature of −25° C. and heat loss of 10 kg/h. 27 kg of aroma was recovered and 1403 kg of slurry was also collected. The slurry was then added to a press wherein 1132 kg of extract was recovered composed of 21 kg of soluble solids, 1104 kg of water and 7 kg of insoluble solids. The extract was then centrifuged and 1076 kg of extract solution was recovered composed of 20 kg of soluble solids, 1055 kg of water and 1 kg of insoluble solids. Also recovered was 57 kg of sludge composed of 1 kg of soluble solids, 49 kg of water and 6 kg of insoluble solids. Overall there was a 72.7% soluble solids recovery with a yield of 0.20 kg soluble solids/kg of black tea.

The black tea aroma collected was evaluated by adding directly to water at different dosages and found that the aroma profile is excellent but the concentration is too low to be limited use in many applications. Also, the aroma has to be stored in cold conditions with very short shelf-life due to its high water content or water activity.

The aroma solution (27 kg) was then added to the spinning cone column the second time under the same conditions as the first step running through the tea slurry and 0.53 kg of concentrated black tea aroma was obtained.

The concentrated black tea aroma was reconstituted with purified water (about 50 times) and evaluated against the original black tea aroma from the first run. The results indicated that the flavor profiles of the two are very similar. The concentrated black tea aroma could be mixed with food-graded alcohol to achieve an alcohol level of 30-50%, which make the concentrated tea aroma stable at ambient temperature for at least one year and meet the requirement for various applications.

What is claimed is:

1. A process for the preparation of a concentrated tea aroma comprising the steps of:
grinding tea leaves in a sealed system;
adding the tea leaves to a feed tank filled with a fixed amount of water;
mixing thoroughly to form a tea leave slurry;
introducing the resulting slurry into a spinning cone column (SCC) and treating the slurry with steam under the following conditions: the offset temperature from about −100° C. to about 50° C., an external stripping rate from about 0.5 to about 50%;
separating tea solids from the spent tea leave;
collecting the tea aroma from the spinning cone column;
reintroducing the tea aroma through the spinning cone column a second time with the following conditions: the offset temperature from about −100 to about 0° C., an external stripping rate from about 0.5 to about 50%; and
providing a concentrated tea aroma.

2. The process according to claim 1, wherein the resulting tea-extract is concentrated and then spray-dried to provide a tea powder.

3. The process according to claim 1, wherein the strip rate is from about 1.0 to about 20% and the tea flavor is selected from black tea, green tea, oolong tea, yellow tea, white tea, toasted tea, barley tea, brown rice tea, and combinations thereof.

4. A process for the preparation of a beverage, the process comprising adding the tea aroma obtained by the process according to claim 3 to a beverage in an amount from about 0.001 from about 20% by weight.

5. A process for the preparation of a flavor, the process comprising adding the tea aroma obtained by the process according to claim 3 to a flavor in an amount from about 0.1 to about 70% by weight.

6. A process for the preparation of a concentrated herbal aroma comprising the steps of:
grinding herbs or the mixture of herbs with other materials in a sealed system and adding them to a feed tank filled with fixed amount water;
mixing thoroughly with stirring to form a slurry of herb or herb mixtures;
introducing the resulting slurry into a spinning cone column (SCC) and treating the slurry with steam under the following conditions: the offset temperature from about −100° C. to about 50° C., an external stripping rate from about 0.5 to about 50%;
separating herb solids from the spent leaves;
collecting the herbal aroma from the spinning cone column;
reintroducing the herbal aroma through the spinning cone column a second time under the following conditions: the offset temperature from about −100 to about 0° C., an external stripping rate from about 1 to about 50%; and
providing a concentrated herbal aroma.

7. The process of claim 6 wherein the herbs are selected from the group consisting of mint, chamomile, basil, lavender, lemon balm, rose, anise hyssop, jasmine, chrysanthemum, osmanthus, medlar, lily, violet, honeysuckle, sage, thyme, ginger, ginseng, gingko, and mixtures thereof.

8. A process for the preparation of a beverage, the process comprising adding the herbal aroma obtained by the process according to claim 6 to a beverage in an amount from about 0.001 to about 20% by weight.

9. A process for the preparation of a beverage, the process comprising adding the tea aroma obtained by the process according to claim 1 and the herbal aroma obtained by the process according claim 6 to a beverage in an amount from about 0.001 to about 20% by weight.

10. A process for the preparation of a flavor, the process comprising adding the herbal aroma obtained by the process according to claim 6 to a flavor in an amount from about 0.1 to about 70% by weight.

11. A concentrated tea product comprising the tea aroma obtained by the process of claim 1 and a food-grade alcohol to provide a stable and concentrated tea product.

12. A concentrated tea product comprising the tea aroma obtained by the process of claim 1, the herbal aroma obtained by the process of claim 6 and a food-grade alcohol to provide a stable and concentrated tea product.
